(19) United States
(12) Patent Application Publication
(10) Pub. No.: US 2025/0310269 A1
(43) Pub. Date: Oct. 2, 2025

(54) MULTI-LINK OPERATION FORWARDING AGGREGATION

(71) Applicant: HEWLETT PACKARD ENTERPRISE DEVELOPMENT LP, Spring, TX (US)

(72) Inventors: Xuguang Jia, Beijing (CN); Xueliang Zhang, Beijing (CN); Yongchang Guo, Beijing (CN)

(21) Appl. No.: 18/619,511

(22) Filed: Mar. 28, 2024

(51) Int. Cl. H04L 47/36; H04L 47/2408

(52) U.S. Cl. CPC H04L 47/36; H04L 47/2408

(57) ABSTRACT

A method for multi-link operation forwarding aggregation is provided. The method comprises obtaining, by an access point (AP), a first Media Access Control Service Data Unit (MSDU) with first payload information via a first link of the AP and a second MSDU with second payload information via a second link of the AP. The method further comprises determining that a destination of the first MSDU is same as a destination of the second MSDU. The method further comprises generating an aggregation frame based on the first MSDU and the second MSDU, the aggregation frame comprising the first payload information of the first MSDU and the second payload information of the second MSDU. In addition, the method further comprises transmitting the aggregation frame to the destination via a wired network. In this way, the forwarding efficiency can be improved.

### BACKGROUND

Multi-link operation (MLO) is a Wi-Fi technology that enables devices connected to an access point (AP) to simultaneously send and/or receive data across different frequency bands and channels. MLO technology is one of the core features added in Wi-Fi 7 that helps enhance the user experience by handling wireless connections more efficiently.

Packets or frames forwarding refers to a process of transferring the packets or the frames from one interface to another interface via a network device (e.g., an AP) based on the destination address information contained in the data. For example, the network device may receive a frame through one of its interfaces. Then, the network device may analyze the destination address contained in frame, such as a Media Access Control (MAC) address, to determine the intended destination. Then, the network device may process the received data depending on the device type and configuration, and transmit the processed data through an outgoing interface determined during a lookup step. Forwarding is a critical function of network devices, enabling communication across different networks or network segments. The forwarding performance and capacity of a device directly impact the overall network throughput and efficiency.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 illustrates an example environment in which example implementations of the present disclosure may be implemented;

FIG. 2 shows a flow chart illustrating a method for MLO forwarding according to the implementations of the present disclosure;

FIG. 3 shows a schematic diagram illustrating an example of MLO forwarding process according to the implementations of the present disclosure;

FIG. 4 shows a schematic diagram illustrating an example process of generating an aggregation frame according to the implementations of the present disclosure;

FIG. 5 shows a schematic diagram illustrating an example Ethernet aggregation frame in the AP uplink according to the implementations of the present disclosure;

FIG. 6A-6B show tables illustrating the payload proportions in frames without aggregation and with aggregation according to the implementations of the present disclosure;

FIG. 7 shows a flow chart illustrating an example process of determining whether to turn on aggregation forwarding or not according to the implementations of the present disclosure;

FIG. 8 shows a schematic diagram illustrating an example process of generating the aggregation frames based on a Differentiated Services Code Point category of the MSDUs according to the implementations of the present disclosure; and

FIG. 9 shows a diagram illustrating an example AP according to the implementations of the present disclosure.

### DETAILED DESCRIPTION

Packet per second (PPS) and bandwidth serve as crucial metrics for evaluating the forwarding capacity of network devices. In typical scenarios, the actual PPS value tends to be less than the theoretical one. With a fixed PPS, maximizing the validity of the payload within each packet contributes to achieving higher throughput. Therefore, a thoughtfully designed aggregation mechanism becomes instrumental in enhancing performance. In the context of the new generation Wi-Fi 7 standard, it becomes imperative to explore efficient approaches for multi-link operation (MLO) forwarding.

When a network device, which is a multi-link device (MLD), is forwarding frames received through a Wireless Local Area Network (WLAN) to a destination through a wired network, the network device may receive 802.11 frames via multiple links and encapsulate the received 802.11 frames as the payload of Ethernet frames. Then, the encapsulated Ethernet frames may be transmitted through a wired network to the destination. For example, an access point (AP) MLD may forward frames received from wireless clients to a controller through Ethernet. The AP may receive frames from clients via multiple links and transfer these received frames into Media Access Control Service Data Units (MSDUs), where each of the MSDUs comprises multiple header fields and a payload field.

In some related schemes, the AP may transmit frames from multiple links to the controller one by one, even if the frames could have same source and destination. In some further related schemes, each link of the AP may aggregate the frames separately. If one link has received an aggregated MSDU (AMSDU) packet on a Wi-Fi interface, this link may have a list of MSDUs, then the AP may use a jumbo frame to transmit the MSDUs through an uplink interface to a controller via Ethernet. Therefore, multiple sets of frame headers and multiple payloads are transmitted. However, in some cases, the received packets are coming from different links of a client MLD, such that destinations of the MSDUs are likely to be the same destination, which means that the header fields of the MSDUs are similar. Thus, the multiple sets of frame headers contain redundant information, which will reduce the forwarding efficiency.

Therefore, the implementations of the present disclosure provide a scheme for MLO forwarding aggregation. In this scheme, an AP may obtain a first MSDU with first payload information via a first link of the AP and a second MSDU with second payload information via a second link of the AP. Then, the AP may determine that a destination of the first MSDU is same as a destination of the second MSDU. Furthermore, the AP may generate an aggregation frame based on the first MSDU and the second MSDU, where the aggregation frame comprises the first payload information of the first MSDU and the second payload information of the second MSDU. In addition, the AP may transmit the aggregation frame to the destination via a wired network.

In this manner, the aggregation frame has only one set of header fields but contains payload information of multiple MSDUs. Therefore, the proportion of the payload information in the aggregation frame can be increased, and the forwarding efficiency can be improved.

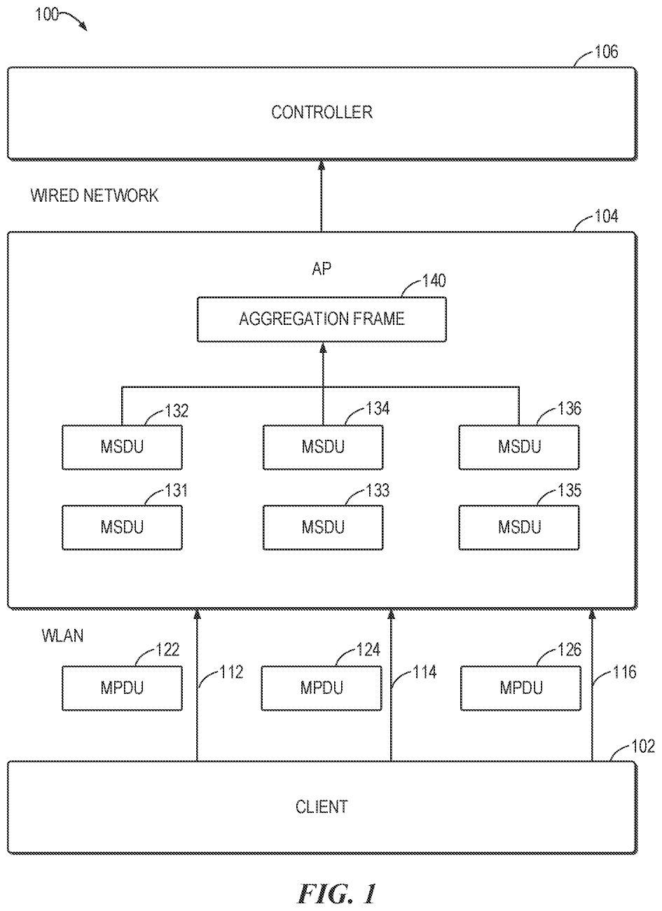

FIG. 1 illustrates an example environment 100 in which example implementations of the present disclosure may be implemented. As shown in FIG. 1, the environment 100 comprises a client 102, an AP 104, and a controller 106. Client 102 and AP 104 are MLO devices, thereby data may be transferred via multiple links. For example, as shown in FIG. 1, in the environment 100, there are three links 112, 114, and 116 between the client 102 and the AP 104. The AP 104 may receive data from the client 102 over WLAN. For example, the AP 104 may receive an MAC Protocol Data Unit (MPDU) 122 via the link 112, an MPDU 124 via the link 114, and an MPDU 126 via the link 116. It should be noted that for ease of illustration, only three links are shown in FIG. 1, but there may be fewer or more links between the client 102 and the AP 104, and the present disclosure is not intended to limit the number of links of the MLO devices.

In the environment 100, after receiving the MPDUs 122, 124, and 126, the AP 104 may unpack the MPDU 122 to obtain MSDUs 131 and 132, unpack the MPDU 124 to obtain MSDUs 133 and 134, and unpack the MPDU 126 to obtain MSDUs 135 and 136, where these MSDUs may comprise destination address information. In some related schemes, these MSDUs may be encapsulated into Ethernet 802.3 frames as payload of the Ethernet frames. Then, these Ethernet frames may be transmitted to the controller 106 over wired network one by one based on the destination address information. However, while some of the MSDUs 131, 132, 133, 134, 135 and 136 are received from different links of the AP 104, they all originate from the client 102. Consequently, they are likely to have the same destination, indicating that the header fields of the MSDUs are similar. Thus, the headers of the Ethernet frames may contain redundant information, which will reduce the forwarding efficiency.

Therefore, in some implementations of the present disclosure, the AP 104 may determine that the MSDUs 131, 132, 133, 134, 135, and 136, which are received from different links, have a same destination. Then, the AP 104 may aggregate these MSDUs into an aggregation frame 140 which comprises the payload information of all these MSDUs but only has one set of headers fields. Then, the AP 104 may transmit the aggregation frame 140 to the controller 106 based on the destination address of the aggregation frame 140 (i.e., the destination address of the MSDUs).

In this manner, the payload of the aggregation frame 140 has only one set of header fields but contains the payload information of the MSDUs 131, 132, 133, 134, 135, and 136. Consequently, these MSDUs received from the multiple links can be transmitted in one frame. Therefore, the proportion of the payload information in the aggregation frame 140 can be increased, and the forwarding efficiency can be improved.

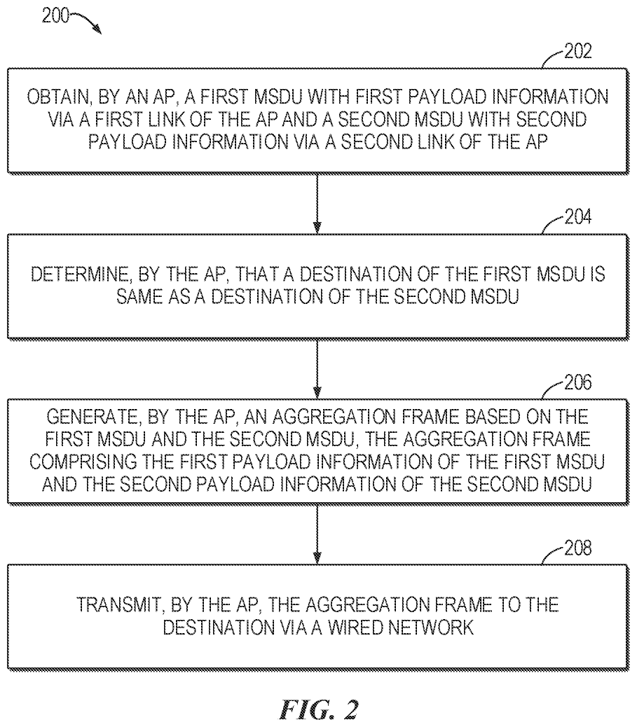

FIG. 2 shows a flow chart illustrating a method 200 for MLO forwarding according to the implementations of the present disclosure. The method 200 may be implemented by, for example, the AP 104 in FIG. 1. As shown in FIG. 2, at block 202, the method 200 may obtain a first MSDU with first payload information via a first link of the AP and a second MSDU with second payload information via a second link of the AP. For example, in the environment 100, as shown in FIG. 1, the AP 104 may receive the MSDU 131 from the client 102 via the link 112 and receive the MSDU 133 from the client 102 via the link 114. The MSDU 131 and the MSDU 133 each have their own payload.

At block 204, the method 200 may determine that a destination of the first MSDU is the same as a destination of the second MSDU. For example, in the environment 100, as shown in FIG. 1, the AP 104 may determine that a destination address of the MSDU 131 is same as a destination of the MSDU 133. As an MLO sender device, the client 102 may transmit data in parallel through multiple links at the same time. For example, the client 102 may split the same data flow into multiple MSDUs. The multiple MSDUs may be packed as the MPDU 122, 124, and 126. The MPDU 122, 124, and 126 may be sent out from different links (i.e., the links 112, 114, and 116). Although these MSDUs are transmitted via different links, they all point to the same final destination address (e.g., an address of the controller 106). As an MLO receiver, the AP 104 may find that after receiving these MSDUs from different links, they have exactly the same destination address, which leaves room for improving forwarding efficiency.

At block 206, the method 200 may generate an aggregation frame based on the first MSDU and the second MSDU, the aggregation frame comprising the first payload information of the first MSDU and the second payload information of the second MSDU. For example, in the environment 100, as shown in FIG. 1, the AP 104 may generate the aggregation frame 140 based on the MSDU 131 and the MSDU 133 (and the other MSDUs in FIG. 1). The aggregation frame 140 may comprise the payload information of the MSDU 131 and the payload information of the MSDU 133.

At block 208, the method 200 may transmit the aggregation frame to the destination via a wired network. For example, in the environment 100, as shown in FIG. 1, the AP 104 may transmit the aggregation frame 140 to the controller 106. For example, the AP 104 may construct an Ethernet frame by encapsulating the aggregation frame 140 into a new Ethernet frame and adding an Ethernet (ETH) header. Then, the AP 104 may transmit the constructed Ethernet frame through a wired Ethernet interface connected to the controller 106.

In this manner, the payload of the aggregation frame 140 has only one set of header fields but contains the payload information of the MSDU 131 and the MSDU 133. Consequently, these MSDUs received from the multiple links can be transmitted in one frame. Therefore, the proportion of the payload information in the aggregation frame 140 can be increased, and the forwarding efficiency can be improved.

In some implementations, the AP supports an AMSDU frame format, and generating, by the AP, the aggregation frame based on the first MSDU and the second MSDU comprises generating the aggregation frame based on the first MSDU and the second MSDU by using the AMSDU frame format.

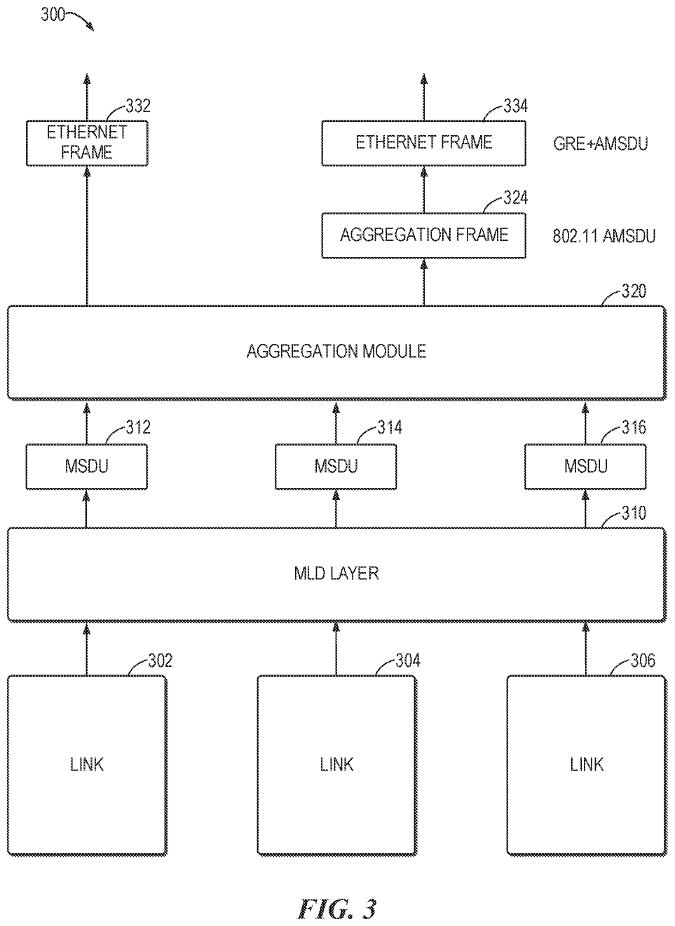

FIG. 3 shows a schematic diagram illustrating an example 300 of MLO forwarding process according to the implementations of the present disclosure. As shown in FIG. 3, an AP comprises links 302, 304, and 306. The AP may receive AMSDUs as MPDUs via the links 302, 304, and 306 and subsequently transfer the AMSDUs to the MLD layer 310. The MLD layer 310 within the AP is a critical functional layer responsible for coordinating and managing various multi-link operations when the AP functions as an MLO device. The MLD layer 310 may identify the boundaries of each sub-frame contained in the AMSDU by parsing the delimiter subfield of the sub-frame header of the A-MSDU. For each sub-frame, the MLD layer 310 treats it as an independent MSDU for processing. In the example 300, MSDUs 312, 314, and 316 may be extracted by the MLD layer 310 from the received AMSDUs.

As shown in FIG. 3, an aggregation module 320 may determine whether the MSDUs 312, 314, and 316 can be aggregated based on the destination address of these MSDUs. In the example 300, the MSDU 314 and the MSDU 316 have the same destination address, but the MSDU 312 has a different destination address than the MSDUs 314 and 316. Therefore, the MSDU 312 may be encapsulated into an Ethernet frame 332, which contains the payload of the MSDU 312, and then the Ethernet frame 332 may be sent out through a wired interface. Because the MSDU 314 and the MSDU 316 have the same destination address, the aggregation module 320 may generate an aggregation frame 324 based on the MSDU 314 and the MSDU 316, where the aggregation frame 324 may contain the payload of the MSDU 314 and the MSDU 316.

In order to aggregate the MSDU 314 and the MSDU 316, a new aggregation protocol is required, and both the AP that generates the aggregation frame 324 and the receiver that receives the aggregation frame 324 need to support this aggregation protocol. Creating a new aggregation protocol is tedious, and getting a variety of devices to support this new aggregation protocol is difficult and expensive. Therefore, in order to avoid introducing a new protocol, in some implementations, the AMSDU protocol of WLAN, which is supported by both AP clients and controller/central, may be reused. In the example 300, the aggregation frame 324 may be generated by using the AMSDU frame format. In other words, the MSDU 314 and the MSDU 316 may be aggregated in an AMSDU, and then the AMSDU may be encapsulated into the aggregation frame 324, which comprises an 802.11 header and the AMSDU. Then, the aggregation frame 324 may be encapsulated into an Ethernet frame 334 with an Ethernet header and a Generic Routing Encapsulation (GRE) header. The Ethernet frame 334, which contains the payload of the MSDU 314 and the payload of the MSDU 316 may be sent out through a wired interface.

In this manner, the MSDUs from different links can be aggregated into an aggregation frame without introducing new protocols, so that both the sender and receiver of the aggregation frame can use the supported AMSDU protocol to parse the aggregation frame, thereby the difficulty and overhead of supporting new protocols can be reduced.

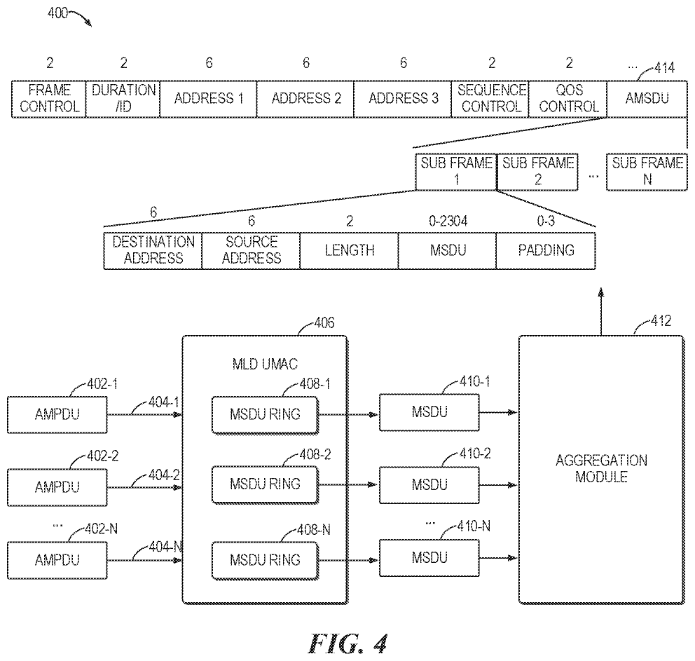

FIG. 4 shows a schematic diagram illustrating an example process 400 of generating an aggregation frame according to the implementations of the present disclosure. As shown in FIG. 4, in the process 400, an MLD Upper MAC (UMAC) 406 of an AP MLD may receive aggregated MPDUs (AMPDUs) 402-1, 402-2, . . . , 402-N (also collectively referred to as the AMPDU 402) from multiple links 404-1, 404-2, . . . , 404-N (also collectively referred to as the link 404). The MLD UMAC 406 may extract MSDUs 410-1, 410-2, . . . , 410-N (also collectively referred to as the MSDU 410) from the AMPDU 402 and store the MSDUs 410 into the MSDU ring 408-1, 408-2, . . . , 408-N (also collectively referred to as the MSDU ring 408). In the example process 400, an aggregation module 412 may determine that the MSDUs 410 have the same destination, and then the aggregation module 412 may generate an aggregation frame 414 in AMSDU frame format based on the MSDUs 410.

As shown in FIG. 4, the aggregation frame 414 is an 802.11 AMSDU frame comprising a frame control field (2 bytes), a duration/ID field (2 bytes), an address 1 field (6 bytes), an address 2 field (6 bytes), an address 3 field (6 bytes), a sequence control field (2 bytes), a Quality of Service (QOS) control field (2 bytes) and an AMSDU field (the length of the AMSDU field depends on the maximum length of the aggregation frame 414). It should be not that, in some other implementations, the aggregation frame 414 may have fewer or more fields. For example, the aggregation frame 414 may also comprise an address 4 field.

As shown in FIG. 4, the AMSDU field of the aggregation frame may comprise multiple sub frame fields, i.e., a sub frame 1 field, a sub frame 2 field, . . . , a sub frame N field. Each sub frame field contain a MSDU field (0-2304 bytes) and some other fields such as destination address (6 bytes), source address (6 bytes), length (2 bytes), and padding (0-3 bytes). For example, the MSDU 410-1 from the link 404-1 may be contained in the sub frame 1 field, the MSDU 410-2 from the link 404-2 may be contained in the sub frame 2 field, and the MSDU 410-N from the link 404-N may be contained in the sub frame N field. In this manner, the MSDUs from different links with the same destination can be aggregated into one aggregation frame, sharing one set of header fields.

In some implementations, generating the aggregation frame based on the first MSDU and the second MSDU by using the AMSDU frame format comprises generating the aggregation frame by assigning a value indicating no encryption for data to a corresponding bit in a frame control field of the aggregation frame. In some implementations, generating the aggregation frame based on the first MSDU and the second MSDU by using the AMSDU frame format comprises generating a virtual AP MLD address and a station (STA) MLD address for the first MSDU and the second MSDU; and generating the aggregation frame by assigning the virtual AP MLD address and the STA MLD address to address fields in the aggregation frame.

In the process 400, as shown in FIG. 4, the AP may assign a value indicating no encryption for data to a corresponding bit in the frame control field of the aggregation frame 414. For example, when a frame is handled by encryption, a protected frame bit in the frame control field may be set to 1, and a frame body field may begin with a cryptographic header. Therefore, this protected frame bit may be set to 0 in the aggregation frame 414. In this manner, only the format of the AMSDU frame can be reused without encrypting the data, ensuring that the receiver can obtain the data contained in the aggregated frame 414.

In addition, in the process 400, because the MLD address for the MSDUs 410 generated by the MLD UMAC 406 are same, the AP may generate a virtual AP MLD address and an STA MLD address for the MSDUs 410. Then, the AP may generate the aggregation frame 414 by assigning the virtual AP MLD address and the STA MLD address to the address fields in the aggregation frame 414 (e.g., assigning the virtual AP MLD address to the address 1 field and assigning the STA MLD address to the address 2 field). In this manner, the receiver of the aggregate frame 414 can directly obtain the address from the header of the aggregate frame 414 without further checking the content of the sub frames in the AMSDU field. Thus, the efficiency of processing the aggregate frame 414 can be improved.

In some implementations, the aggregation frame is a jumbo frame, and generating the aggregation frame based on the first MSDU and the second MSDU by using the AMSDU frame format comprises determining a size of an AMSDU field of the aggregation frame; determining a maximum number of MSDUs in the aggregation frame based on the size of the AMSDU field of the aggregation frame; and generating the aggregation frame based on the maximum number of MSDUs in the aggregation frame. In some implementations, determining the size of the AMSDU field of the aggregation frame comprises determining a maximum size of the jumbo frame; determining a size of header fields of the aggregation frame; and determining the size of the AMSDU field of the aggregation frame based on the maximum size of the jumbo frame and the size of the header fields.

In the process 400, as shown in FIG. 4, the aggregation frame 414 may be a jumbo frame. Jumbo frames refer to Ethernet frames that exceed the 1500 bytes payload limit established by the 802.3 standard. The payload limit for jumbo frames may vary, with 9000 bytes being the most frequently employed limit, although smaller and larger limits are also in use. In the process 400, the AP may determine a maximum size of a jumbo frame (e.g., 9000 bytes) and a size of the header fields of the aggregation frame 414 (e.g., 26 bytes in the example of FIG. 4). Then, the AP may determine a size of the AMSDU field based on the maximum size of a jumbo frame and the size of the header fields of the aggregation frame 414. For example, the size of the AMSDU field in the example of FIG. 4 may be 8974 bytes (i.e., 9000-26 bytes). Therefore, the AP may determine a maximum number of MSDUs in the aggregation frame 414 based on the size of the AMSDU field, and may generate the aggregation frame 414 based on the maximum number of MSDUs. In this manner,

In this manner, each aggregation frame can accommodate a greater number of MSDUs, thus the data transfer efficiency can be improved. Furthermore, because the aggregation frame can accommodate a greater number of MSDUs, the total number of the aggregation frames can be reduced. Thus, the header overhead of the aggregation frames can be reduced.

In some implementations, generating the aggregation frame based on the first MSDU and the second MSDU by using the AMSDU frame format comprises determining a sequence number for the aggregation frame based on a sequence number of the first MSDU and a sequence number of the second MSDU; and generating the aggregation frame by assigning the determined sequence number to the sequence number field in header fields of the aggregation frame. In some implementations, determining the sequence number for the first MSDU and the second MSDU comprises determining a minimum value of the sequence number of the first MSDU and the sequence number of the second MSDU as the sequence number for the aggregation frame; or determining a maximum value of the sequence number of the first MSDU and the sequence number of the second MSDU as the sequence number for the aggregation frame.

In the process 400, as shown in FIG. 4, the sequence control field of the aggregation frame 144 comprises two subfields, a sequence number field, and a fragment number field. The sequence number field indicates a sequence number of the transmitted MSDU, ensuring the order and integrity of the MSDUs during the transmission. In the process 400, the sequence number of the aggregation frame 414 may be determined based on the sequence number of the MSDUs contained in the sub frames. In order to keep the consistency and the correct order of multiple aggregation frames, the process 400 may determine the minimum sequence number (or the maximum sequence number) among the sequence numbers of the MSDUs in the aggregation frame 414 as the sequence number of the aggregation frame 414. When generating the next aggregation frame, the AP may always use the minimum sequence number (or the maximum sequence number) as the sequence number of the aggregation frame. In this manner, the process 400 can ensure that the aggregation frames are in the correct order during transmission.

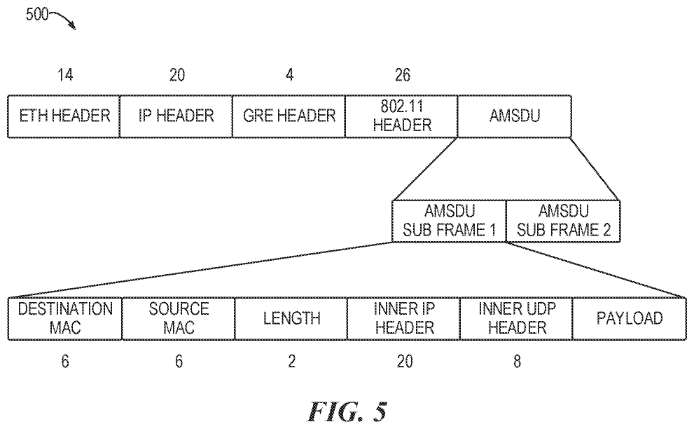

FIG. 5 shows a schematic diagram illustrating an example Ethernet aggregation frame in the AP uplink according to the implementations of the present disclosure. As shown in FIG. 5, the aggregation frame 500 comprises an ETH header field (14 bytes), an IP header field (20 bytes), a GRE header field (4 bytes), an 802.11 header field (26 bytes) and an AMSDU field. The AMSDU field comprises an AMSDU sub frame 1 and an AMSDU sub frame 2, and each AMSDU sub frame field comprises a destination MAC address field (6 bytes), a source MAC address field (6 bytes), a length field (2 bytes), an inner IP header field (20 bytes), an inner User Datagram Protocol (UDP) header field (8 bytes) and a payload field.

The ETH header field may comprise the MAC addresses of the source and the destination devices, identifying the sender and the receiver in an Ethernet network. Furthermore, the ETH header field may also comprise a frame type field indicating the type or length of the data, such as IPv4, IPv6, etc., allowing the recipient to know how to parse the data packet. The IP header field may comprise the source and destination device IP addresses, identifying the sender and receiver at the network layer. The GRE header field may comprise a protocol type field indicating the upper-layer protocol type encapsulated by GRE, such as IP, IPv6, etc. Therefore, The ETH header offers device identification and frame type at the physical layer, the IP header provides device identification and network protocol information at the network layer, while the GRE header supports encapsulation and tunneling, enabling secure data transmission across networks.

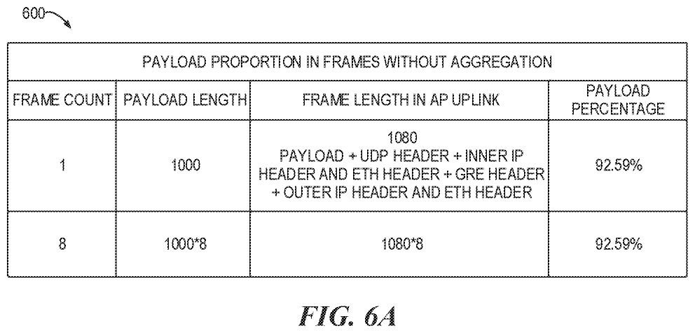

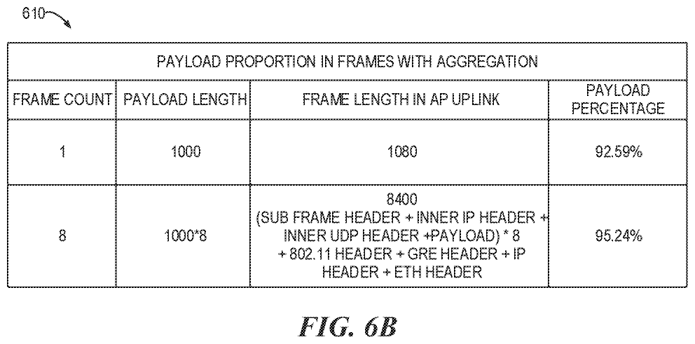

FIG. 6A shows a table 600 illustrating the payload proportion in frames without aggregation according to the implementations of the present disclosure. As shown in table 600, in the case that there is only a single frame to be forwarded, and considering the payload length of the frame to be 1000 bytes, the total frame length in the AP uplink could be 1080 bytes. This includes 8 bytes for UDP header, 34 bytes for the inner IP header and ETH header, 4 bytes for the GRE header, and an additional 34 bytes for the outer IP header and ETH header. Therefore, the payload percentage is 1000/1080 or about 92.59%. In the case that there are eight frames to be forwarded, these frames may be transmitted individually without MLO aggregation. The payload length of these frames could be 1000*8 bytes, and the total frame length in the AP uplink could be 1080*8 bytes. Therefore the payload percentage is 92.59% as well.

FIG. 6B shows a table 610 illustrating the payload proportion in frames with aggregation according to the implementations of the present disclosure. As shown in table 610, in the case that there is only a single frame to be forwarded, the payload length (1000 bytes), total frame length in the AP uplink (1080 bytes) and the payload percentage (92.59%) are the same with the values in the table 600. However, through MLO aggregation and the utilization of jumbo frames, it becomes possible to aggregate frames from various links into a single aggregation frame. Consequently, this aggregation frame may encompass all the payloads from the eight frames. As shown in FIG. 6B, the aggregation frame consists of eight sets of fields that cannot be shared, each containing a sub-frame header (14 bytes), an inner IP header (20 bytes), an inner UDP header (8 bytes), and a payload (1000 bytes). In addition, the aggregation frame further comprises one set of header fields containing an 802.11 header (26 bytes), a GRE header (4 bytes), an IP header (20 bytes), and an ETH header (14 bytes). Therefore, the total frame length in the AP uplink is 8400 bytes (i.e., (14+20+8+1000)*8+26+4+20+14), and the payload percentage is 8000/8400 or about 95.24%. In this manner, the valid payload percentage can be improved, and the forwarding efficiency can also be improved.

In order to aggregate multiple frames into a single aggregation frame, the frame that arrives first needs to wait for a period of time for the other frames with the same destination, which may cause latency and jitter. In some implementations, generating the aggregation frame based on the first MSDU and the second MSDU may comprise determining a maximum number of MSDUs in the aggregation frame based on the size of the aggregation frame; determining a time threshold to wait for a plurality of MSDUs to be aggregated; and generating the aggregation frame containing a plurality of MSDUs based on the maximum number of MSDUs and the time threshold. For example, if the time used to wait for multiple MSDUs is greater than the tolerable latency, the MSDUs that have been received will be aggregated and forwarded when the time threshold is reached without continuing to wait for the number of MSDUs to reach the maximum value. In this manner, a balance between the latency and the forwarding efficiency can be achieved. Thereby, the user experience can be improved.

In some implementations, the AP may determine, dynamically, an aggregation probability based on a plurality of MSDUs transmitted in a time period; in response to the aggregation probability being greater than or equal to a probability threshold, the AP may turn on the aggregation forwarding; and in response to the aggregation probability being smaller than the probability threshold, the AP may turn off the aggregation forwarding. In some implementations, determining the aggregation probability based on the plurality of MSDUs transmitted in the time period may comprise determining a ratio of MSDUs with a same traffic identifier (TID) and a same destination within the time period to all MSDUs within the time period as the aggregation probability.

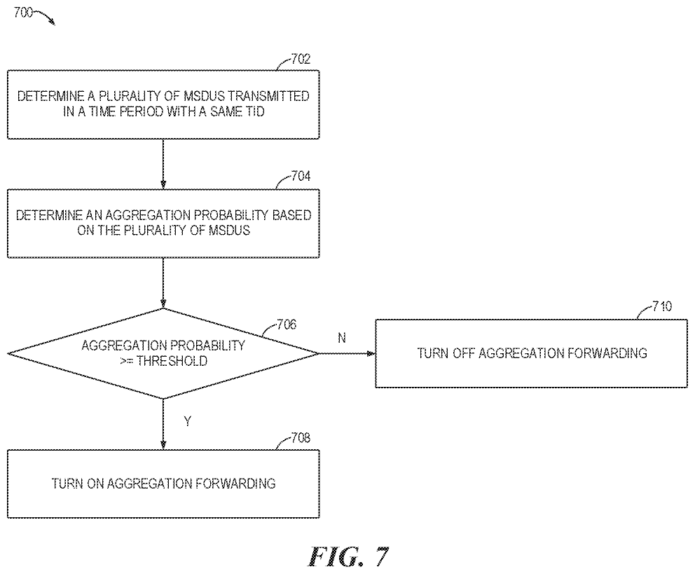

FIG. 7 shows a flow chart illustrating an example process 700 of determining whether to turn on aggregation forwarding or not according to the implementations of the present disclosure. As shown in FIG. 7, at block 702, the process 700 may determine a plurality of MSDUs transmitted in a time period with a same TID. The MSDUs with the same TID are more likely to have the same destination address. For example, a hash table may be established based on the destination address of the MSDU transmitted in a time period (e.g., 100 ms).

At block 704, the process 700 may determine an aggregation probability based on the plurality of MSDUs. For example, the AP may count a number of MSDUs with a same destination address. The aggregation probability may be determined based on the number of MSDUs with the same destination address and the total number of MSDUs in the hash table. For example, if within the last 100 ms, 60% of the MSDUs have the same destination address, the aggregation probability may be determined as 60%. The aggregation probability may indicate whether MSDUs should undergo aggregation in the aggregation module. Furthermore, the aggregation probability is not a fixed or a predetermined value but is calculated dynamically during the data transmission.

At block 706, the process 700 may compare the aggregation probability with a predetermined threshold. If the aggregation probability is greater than or equal to the predetermined threshold, the process 700 may move to block 708. At block 708, the process 700 may turn on the aggregation forwarding. Otherwise, if the aggregation probability is less than the predetermined threshold, the process 700 may move to block 710. At block 710, the process 70 may turn off the aggregation forwarding. For example, if the predetermined threshold is 50% and 60% of the MSDUs have the same destination address, the AP may turn on the MLO aggregation forwarding, and the MSDUs with the same destination address can be aggregated. If the predetermined threshold is 50% and 40% of the MSDUs have the same destination address, the AP may turn off the MLO aggregation forwarding.

In this manner, in the case of a lower aggregation probability, the latency caused by waiting for MSDUs with the same destination address can be reduced. Furthermore, in the case of a higher aggregation probability, the MSDUs with the same destination address can be aggregated, thereby the forwarding efficiency can be improved.

In some implementations, generating the aggregation frame based on the first MSDU and the second MSDU may comprise determining a differentiated services code point (DSCP) category of the first MSDU and the second MSDU; in response to the DSCP category being voice or video, transmitting the first MSDU and the second MSDU without generating the aggregation frame; and in response to the DSCP category being best effort or background, generating the aggregation frame based on the first MSDU and the second MSDU.

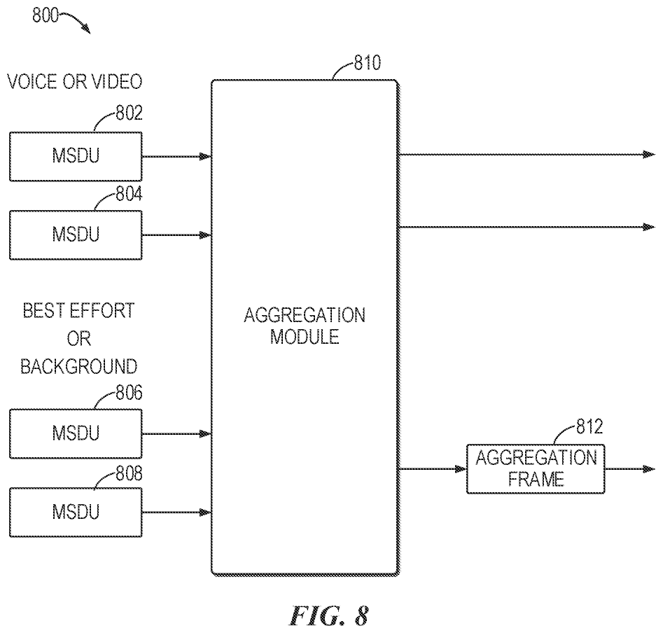

FIG. 8 shows a schematic diagram illustrating an example process 800 of generating the aggregation frames based on a DSCP category of the MSDUs according to the implementations of the present disclosure. DSCP is a technique used to grade and differentiate network traffic. DSCP value may be specified in the service type field of the header to identify and distinguish different types of traffic. DSCP classification allows network administrators to divide data traffic into multiple categories based on priority and service requirements, assigning different priorities and processing policies to each category.

Commonly used DSCP categories may comprise voice, video, best effort, and background. The voice traffic refers to real-time communication such as voice over Internet protocol (VoIP) calls. It requires low latency, minimal jitter, and high reliability to ensure clear and uninterrupted voice transmission. The video traffic comprises streaming video content, video conferencing, and other multimedia applications. It requires consistent bandwidth, low latency, and moderate jitter to provide smooth and high-quality video playback. Best effort traffic refers to general data traffic that does not have specific QOS requirements. This type of traffic is typically considered non-critical and is handled on a “best effort” basis by the network. The background traffic comprises low-priority data transfers, software updates, and other non-urgent activities. It is characterized by its low impact on network performance and can tolerate delays or fluctuations in bandwidth.

As shown in FIG. 8, the MSDUs 802 and 804 are voice or video traffic, and the MSDUs 806 and 808 are best effort or background traffic. An aggregation module 810 may check the DSCP categories of these MSDUs and determine whether to aggregate these MSDUs based on their DSCP categories. Because the requirements of consistent bandwidth, low latency, and minimal jitter for the voice and video traffic to ensure clear and uninterrupted voice transmission or smooth and high-quality video playback, the MSDUs 802 and 804 may be forwarded directly without the need to wait for other MSDUs to aggregate. For example, if the MSDU 802 arrives first, it may be forwarded immediately without having to wait for the MSDU 804. In addition, because the best effort and background traffics are considered non-critical and can tolerate latency, if the MSDU 806 arrives first, it may wait for the MSDU 808, which has the same destination as the MSDU 806, and then the MSDUs 806 and 808 may be aggregated by the aggregation module 810, generating an aggregation frame 812.

In this manner, for the voice and video traffic, the latency and jitter can be reduced. For the best effort and background traffic, such as visiting websites and downloading files, the process of loading web pages can be faster and smoother, thereby the user experience can be improved.

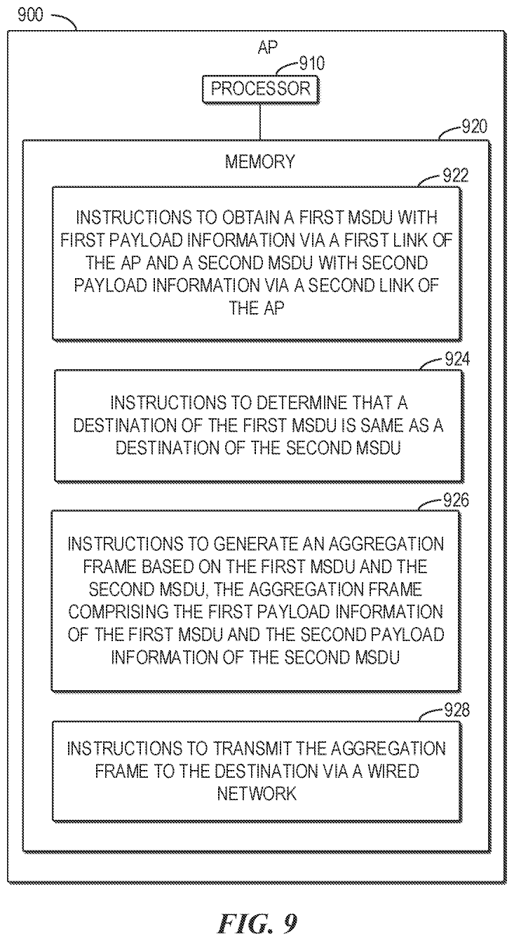

FIG. 9 shows a diagram illustrating an example AP 900 according to the implementations of the present disclosure. As shown in FIG. 9, the AP 900 comprises at least one processor 910, and a memory 920 coupled to the at least one processor 910. The memory 920 stores instructions 922, 924, 926, and 928 to cause the processor 910 to perform actions according to example implementations of the present disclosure.

As shown in FIG. 9, the memory 920 stores instructions 922 to obtain a first Media Access Control Service Data Unit (MSDU) with first payload information via a first link of the AP and a second MSDU with second payload information via a second link of the AP. The memory 920 further stores instructions 924 to determine that a destination of the first MSDU is same as a destination of the second MSDU. The memory 920 further stores instructions 926 to generate an aggregation frame based on the first MSDU and the second MSDU, the aggregation frame comprising the first payload information of the first MSDU and the second payload information of the second MSDU. In addition, the memory 920 further stores instructions 928 to transmit the aggregation frame to the destination via a wired network.

The stored instructions and the functions that the instructions may perform can be understood with reference to implementations as described above. For brevity, the details of instructions 922, 924, 926, and 928 will not be discussed herein.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method comprising:
obtaining, by an access point (AP), a first Media Access Control Service Data Unit (MSDU) with first payload information via a first link of the AP and a second MSDU with second payload information via a second link of the AP;
determining, by the AP, that a destination of the first MSDU is same as a destination of the second MSDU;
generating, by the AP, an aggregation frame based on the first MSDU and the second MSDU, the aggregation frame comprising the first payload information of the first MSDU and the second payload information of the second MSDU; and
transmitting, by the AP, the aggregation frame to the destination via a wired network.

2. The method of claim 1, wherein the AP supports an aggregated MSDU (AMSDU) frame format, and generating the aggregation frame based on the first MSDU and the second MSDU comprises:
generating the aggregation frame based on the first MSDU and the second MSDU by using the AMSDU frame format.

3. The method of claim 2, wherein generating the aggregation frame based on the first MSDU and the second MSDU by using the AMSDU frame format comprises:
generating the aggregation frame by assigning a value indicating no encryption for data to a corresponding bit in a frame control field of the aggregation frame.

4. The method of claim 2, wherein generating the aggregation frame based on the first MSDU and the second MSDU by using the AMSDU frame format comprises:
generating a virtual AP multi-link device (MLD) address and a station MLD address for the first MSDU and the second MSDU; and
generating the aggregation frame by assigning the virtual AP MLD address and the station MLD address to address fields in the aggregation frame.

5. The method of claim 2, wherein the aggregation frame is a jumbo frame, and generating the aggregation frame based on the first MSDU and the second MSDU by using the AMSDU frame format comprises:
determining a size of an AMSDU field of the aggregation frame;
determining a maximum number of MSDUs in the aggregation frame based on the size of the AMSDU field of the aggregation frame; and
generating the aggregation frame based on the maximum number of MSDUs in the aggregation frame.

6. The method of claim 5, wherein determining the size of the AMSDU field of the aggregation frame comprises:
determining a maximum size of the jumbo frame;
determining a size of header fields of the aggregation frame; and
determining the size of the AMSDU field of the aggregation frame based on the maximum size of the jumbo frame and the size of the header fields.

7. The method of claim 2, wherein generating the aggregation frame based on the first MSDU and the second MSDU by using the AMSDU frame format comprises:
determining a sequence number for the aggregation frame based on a sequence number of the first MSDU and a sequence number of the second MSDU; and
generating the aggregation frame by assigning the determined sequence number to the sequence number field in header fields of the aggregation frame.

8. The method of claim 7, wherein determining the sequence number for the first MSDU and the second MSDU comprises:
determining a minimum value of the sequence number of the first MSDU and the sequence number of the second MSDU as the sequence number for the aggregation frame; or
determining a maximum value of the sequence number of the first MSDU and the sequence number of the second MSDU as the sequence number for the aggregation frame.

9. The method of claim 1, wherein generating the aggregation frame based on the first MSDU and the second MSDU comprises:
determining a maximum number of MSDUs in the aggregation frame based on the size of the aggregation frame;
determining a time threshold to wait for a plurality of MSDUs to be aggregated; and
generating the aggregation frame containing a plurality of MSDUs based on the maximum number of MSDUs and the time threshold.

10. The method of claim 1, further comprising:
determining an aggregation probability based on a plurality of MSDUs transmitted in a time period;
in response to the aggregation probability being greater than or equal to a probability threshold, turning on aggregation forwarding; and
in response to the aggregation probability being smaller than the probability threshold, turning off aggregation forwarding.

11. The method of claim 10, wherein determining the aggregation probability based on the plurality of MSDUs transmitted in the time period comprises:
determining a ratio of MSDUs with a same traffic identifier (TID) and a same destination within the time period to all MSDUs within the time period as the aggregation probability.

12. The method of claim 1, wherein generating the aggregation frame based on the first MSDU and the second MSDU comprises:
determining a differentiated services code point (DSCP) category of the first MSDU and the second MSDU;
in response to the DSCP category being a voice or video, transmitting the first MSDU and the second MSDU without generating the aggregation frame; and
in response to the DSCP category being a best effort or background, generating the aggregation frame based on the first MSDU and the second MSDU.

13. An access point (AP) comprising:
at least one processor; and
a memory coupled to the at least one processor, the memory storing instructions to cause the at least one processor to:
obtain a first Media Access Control Service Data Unit (MSDU) with first payload information via a first link of the AP and a second MSDU with second payload information via a second link of the AP;
determine that a destination of the first MSDU is same as a destination of the second MSDU;
generate an aggregation frame based on the first MSDU and the second MSDU, the aggregation frame comprising the first payload information of the first MSDU and the second payload information of the second MSDU; and
transmit the aggregation frame to the destination via a wired network.

14. The AP of claim 13, wherein the AP supports an aggregated MSDU (AMSDU) frame format, and the instructions to generate the aggregation frame based on the first MSDU and the second MSDU comprises instructions to:
generate the aggregation frame based on the first MSDU and the second MSDU by using the AMSDU frame format.

15. The AP of claim 14, wherein the instructions to generate the aggregation frame based on the first MSDU and the second MSDU by using the AMSDU frame format comprises instructions to:
generate the aggregation frame by assigning a value indicating no encryption for data to a corresponding bit in a frame control field of the aggregation frame.

16. The AP of claim 14, wherein the instructions to generate the aggregation frame based on the first MSDU and the second MSDU by using the AMSDU frame format comprises instructions to:
generate a virtual AP multi-link device (MLD) address and a station MLD address for the first MSDU and the second MSDU; and
generate the aggregation frame by assigning the virtual AP MLD address and the station MLD address to address fields in the aggregation frame.

17. The AP of claim 14, wherein the aggregation frame is a jumbo frame, and the instructions to generate the aggregation frame based on the first MSDU and the second MSDU by using the AMSDU frame format comprises instructions to:
determine a size of an AMSDU field of the aggregation frame;
determine a maximum number of MSDUs in the aggregation frame based on the size of the AMSDU field of the aggregation frame; and
generate the aggregation frame based on the maximum number of MSDUs in the aggregation frame.

18. The AP of claim 17, wherein the instructions to determine the size of the AMSDU field of the aggregation frame comprises instructions to:
determine a maximum size of the jumbo frame;
determine a size of header fields of the aggregation frame; and
determine the size of the AMSDU field of the aggregation frame based on the maximum size of the jumbo frame and the size of the header fields.

19. The AP of claim 14, wherein the instructions to generate the aggregation frame based on the first MSDU and the second MSDU by using the AMSDU frame format comprises instructions to:
determine a sequence number for the aggregation frame based on a sequence number of the first MSDU and a sequence number of the second MSDU; and
generate the aggregation frame by assigning the determined sequence number to the sequence number field in header fields of the aggregation frame.

20. A non-transitory computer-readable medium comprising instructions stored thereon which, when executed by an access point (AP), cause the AP to:
obtain a first Media Access Control Service Data Unit (MSDU) with first payload information via a first link of the AP and a second MSDU with second payload information via a second link of the AP;
determine that a destination of the first MSDU is same as a destination of the second MSDU;
generate an aggregation frame based on the first MSDU and the second MSDU, the aggregation frame comprising the first payload information of the first MSDU and the second payload information of the second MSDU; and
transmit the aggregation frame to the destination via a wired network.
